(19) United States
(12) Patent Application Publication
(10) Pub. No.: US 2020/0094408 A1
(43) Pub. Date: Mar. 26, 2020

(54) DEVICE WHICH SUPPORTS PROGRAMMING FOR ROBOTS

(71) Applicant: DENSO WAVE INCORPORATED, Chita-gun (JP)

(72) Inventors: Daisuke YUI, Chita-gun (JP); Hirota TOUMA, Chita-gun (JP)

(73) Assignee: DENSO WAVE INCORPORATED, Chita-gun (JP)

(21) Appl. No.: 16/582,437

(22) Filed: Sep. 25, 2019

(30) Foreign Application Priority Data
Sep. 25, 2018 (JP) 2018-179455

(51) Int. Cl. B25J 9/16

(52) U.S. Cl. CPC B25J 9/1664; B25J 9/161

(57) ABSTRACT

A programming support device includes a display unit displaying a motion trajectory of an industrial robot positioned corresponding to the robot. The device supports programming wherein move commands and non-move commands are included. The device also includes a first processing unit and a second processing unit. The first processing unit displays each target position of each move command using a first symbol superimposed on the motion trajectory at a position corresponding to the target position. The second processing unit displays the non-move commands executed between the first move command and second move command, by using a second symbol superimposed on the motion trajectory between the target position of the first move command and the target position of the second move command. The device also includes a third processing unit capable of selecting the first symbol and the second symbol, and editing the command corresponding to the selected symbol.

### CROSS-REFERENCE TO RELATED APPLICATION

This application is based on and claims the benefit of priority from earlier Japanese Patent Application No. 2018-179455 filed Sep. 25, 2018, the description of which is incorporated herein by reference.

### BACKGROUND

### Technical Field

The present invention relates to a device which supports programming for robots, and specifically relates to a device which supports (or assists) an operator with regard to programming for industrial robots during the programming process.

### Related Art

Techniques for use in devices which support programming for robots have been known as disclosed in JP-A-2018-51653. The technique disclosed in JP-A-2018-51653 is proposed as a display device for robots, and is directed to recognition of the movement of the robot by an operator in an appropriate manner. Accordingly, JP-A-2018-51653 describes a device that displays a motion trajectory of a robot, start point of branch, and destination of branch by using visually recognizable shapes.

The display device disclosed in JP-A-2018-51653 is configured to recognize only the movement of the robot. Accordingly, there is still a room for improvement in programming for robots.

### SUMMARY

It is thus desired to provide a device which supports programming for industrial robots with improved usability in programming.

A first exemplary embodiment for solving the above problem is a device which supports programming for robots, and includes a display unit that displays a motion trajectory of a robot at a position corresponding to the robot and supports programming in which move commands for moving the robot and non-move commands, which are commands other than the move commands, are included, by using the display unit, the device includes: a first processing unit that displays each target position of each of the move commands by using a first symbol superimposed on the motion trajectory at a position corresponding to the target position; a second processing unit that displays each of the non-move commands executed between the move commands, that is, a first move command and a second move command, by using a second symbol, which is different from the first symbol, superimposed on the motion trajectory between the target position of the first move command and the target position of the second move command; and a third processing unit capable of selecting the first symbol and the second symbol, and editing the command corresponding to the selected symbol.

With this configuration, the display unit displays the motion trajectory of the robot at a position corresponding to the robot. The device which supports programming for robots supports programming, in which move commands for moving the robot and non-move commands, which are commands other than the move commands, are included, by using the display unit.

The first processing unit displays each target position of each of the move commands by using the first symbol superimposed on the motion trajectory at a position corresponding to the target position. Accordingly, an operator can easily recognize each target position of each of the move commands on the motion trajectory of the robot on the basis of the first symbol. The second processing unit displays each of the non-move commands executed between the move commands, that is, the first move command and the second move command, by using the second symbol, which is different from the first symbol, superimposed on the motion trajectory between the target position of the first move command and the target position of the second move command. Accordingly, the operator can intuitively recognize not only the target positions of the move commands, but also the position and timing at which each of the non-move commands are executed on the basis of the second symbol.

The third processing unit is capable of selecting the first symbol and the second symbol, and editing the command corresponding to the selected symbol. Accordingly, the operator can intuitively select the move commands and the non-move commands to edit, and smoothly shift to editing of the commands. Therefore, the programming support device improves usability in programming for robots.

The program of the robot may be described by thousands of lines of commands. Accordingly, it is time-consuming for the operator to find the command to edit in the program.

According to a second exemplary embodiment, the third processing unit displays a portion of the program which includes the command corresponding to the selected symbol on the display unit in an editable state. Accordingly, the operator can easily find the command corresponding to the selected symbol, that is, the command to edit in the program, and edit the command.

According to a third exemplary embodiment, the third processing unit is capable of selecting a part of the program and displaying the selected part of the program on the display unit, and displays, among the motion trajectory, the first symbol, and the second symbol, a portion corresponding to the selected part of the program on the display unit. Accordingly, the operator can easily recognize the motion trajectory, the first symbol, and the second symbol corresponding to the selected part of the program.

According to a fourth exemplary embodiment, the third processing unit is capable of changing a position of the displayed first symbol, and, as the position of the first symbol is changed, the third processing unit rewrites the target position of the move command in the program corresponding to the first symbol that has been changed into a position corresponding to the changed position.

With this configuration, the third processing unit can change the position of the displayed first symbol. Accordingly, when desiring to change the target position of the move command, the operator can change the position of the displayed first symbol. As the position of the first symbol is changed, the third processing unit rewrites the target position of the move command in the program corresponding to the first symbol that has been changed into a position corresponding to the changed position. Accordingly, the operator can easily rewrite the target position of the move command in the program corresponding to the first symbol by changing the position of the displayed first symbol.

According to a fifth exemplary embodiment, the second processing unit displays each of the non-move commands executed between the first move command and the second move command, by using the second symbol, superimposed on the motion trajectory at a position corresponding to the timing when the non-move command is executed between the target position of the first move command and the target position of the second move command.

With this configuration, the second processing unit displays each of the non-move commands executed between the first move command and the second move command, by using the second symbol, at a position corresponding to the timing when the non-move command is executed. Accordingly, the operator can recognize the timing at which each of the non-move commands are executed on the basis of the position of the second symbol.

According to a sixth exemplary embodiment, the second processing unit displays a determination command and a non-determination command among the non-move commands by using different second symbols. Accordingly, the operator can independently recognize the determination command and the non-determination command among the non-move commands.

### BRIEF DESCRIPTION OF THE DRAWINGS

In the accompanying drawings:

FIG. 1 is a block diagram of a robot system according to an embodiment.

FIG. 2 is a flowchart showing steps until program completion.

FIG. 3 is a diagram showing part of a program.

FIG. 4 is a diagram illustrating an image of a robot, motion trajectories, and command symbols.

FIG. 5 is a diagram illustrating an exemplary display on a display of a teaching pendant.

FIG. 6 is a diagram illustrating an exemplary display on a display of a teaching pendant according to a first modification.

FIG. 7 is a diagram illustrating an exemplary display on a display of a teaching pendant according to a second modification.

FIG. 8 is a diagram illustrating an exemplary display on a display of a teaching pendant according to a third modification.

FIG. 9 is a diagram illustrating an exemplary display on a display of a teaching pendant according to a fourth modification.

### DETAILED DESCRIPTION OF THE PREFERRED EMBODIMENTS

With reference to the drawings, an embodiment implemented as a robot system used in the fields such as machine assembly factories will be described.

### First Embodiment

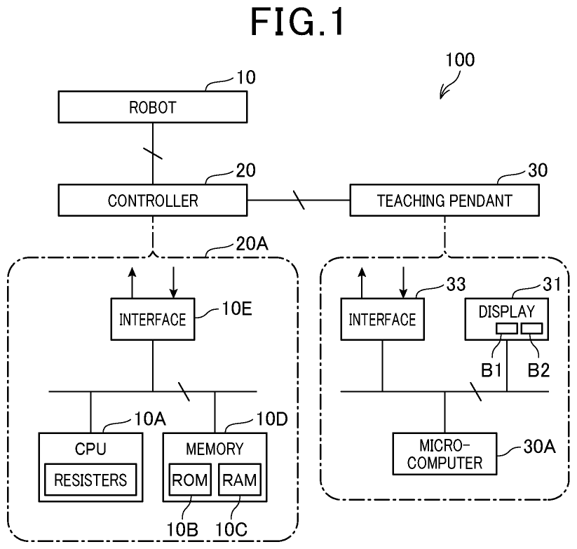

With reference to FIGS. 1 to 5, an embodiment of the present invention will now be described. As shown in FIG. 1, a robot system 100 includes a robot 10, a controller 20, a teaching pendant 30, and the like.

The robot 10 is, for example, a 6-axis vertical articulated robot for industrial use. The robot 10 has a known configuration, and includes a motor (not shown) provided on each axis (not shown) to move an arm (not shown) of the axis. At a distal end of the sixth axis arm (not shown), a tool such as a hand, which is not shown, is attached to perform an operation on a workpiece (not shown), which is a work target.

The controller 20 (control unit) mainly controls the robot 10, and includes a microcomputer 20A having elements such as a CPU 10A provided with a register, a memory 10D including ROM (read-only memory) 10B and RAM (random access memory) 10C, an I/O interface 10E, and a bus 10F for communicatively coupling these elements. The controller 20, that is, the CPU 10A, when actuated, executes programs stored in a storage unit such as a ROM to thereby operate the robot 10. The controller 20 reads programs created by an operator from the teaching pendant 30 into the storage area (e.g., RAM 10C). Further, the controller 20 operates the robot 10 in response to an instruction from the teaching pendant 30 operated by the operator.

The controller 20 recognizes various operation information including information such as an operation state of the robot 10, for example, a current target position of the robot 10 or a motion trajectory along which the robot 10 moves to the target position. Further, the controller 20, which stores and executes the program, recognizes a command currently being executed and a command to be executed subsequent to the current command. The controller 20 outputs various operation information which indicate operation states of the robot 10 to the teaching pendant 30.

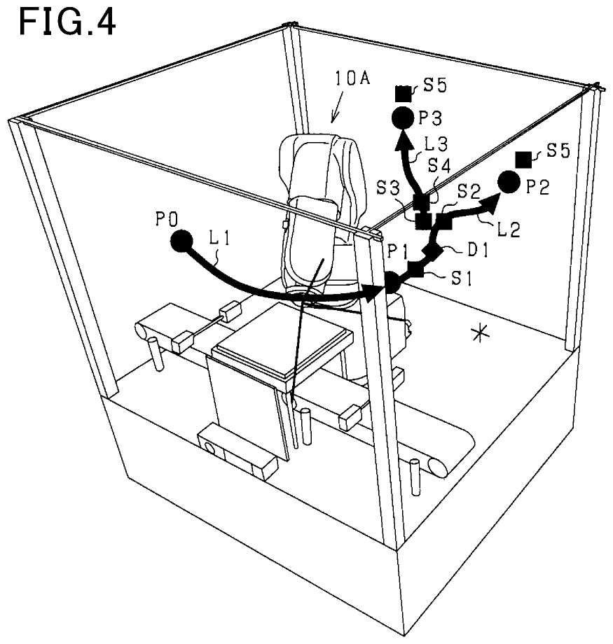

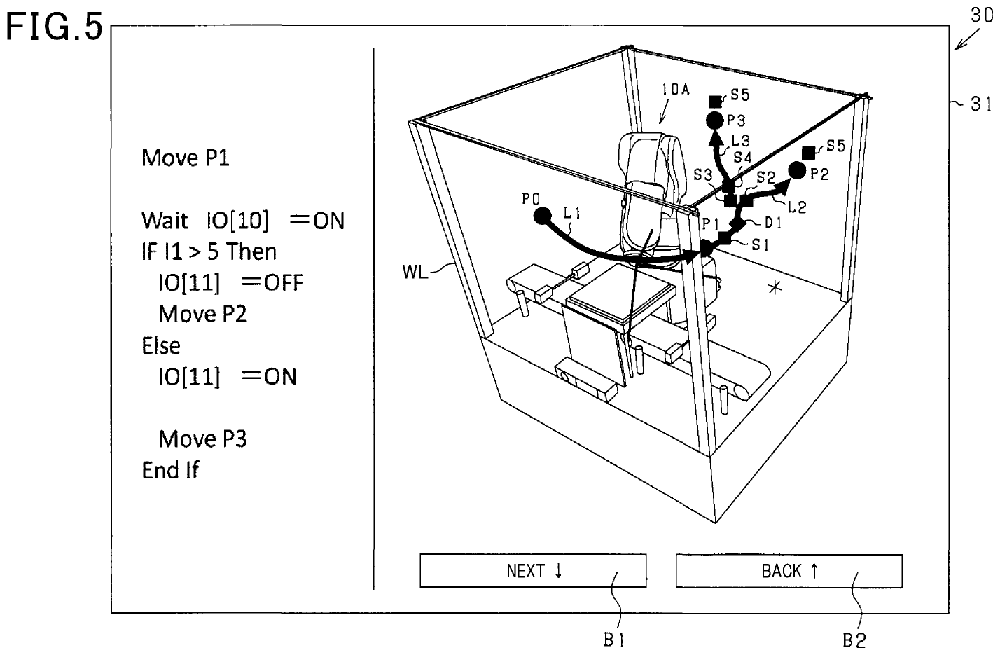

The teaching pendant 30 (teaching device) includes a microcomputer 30A similar to that of the controller 20, various key switches 30B, a display 31 (see also FIG. 5), and an input/output interface 33 communicably connected with those various components. The operator performs various input operations by using the key switches 30B. The operator can operate the teaching pendant 30 (which serves as a programming support device) to create a new program. Accordingly, the teaching pendant 30 creates data indicative of a simulation image of the robot 10 and motion trajectories L1 to L3 (see FIG. 4) based on the program, for example, created with C language and the operation state of the robot 10 outputted from the controller 20, and displays the created data on the display 31. The teaching pendant 30 performs functions of a first processing unit, a second processing unit, and a third processing unit.

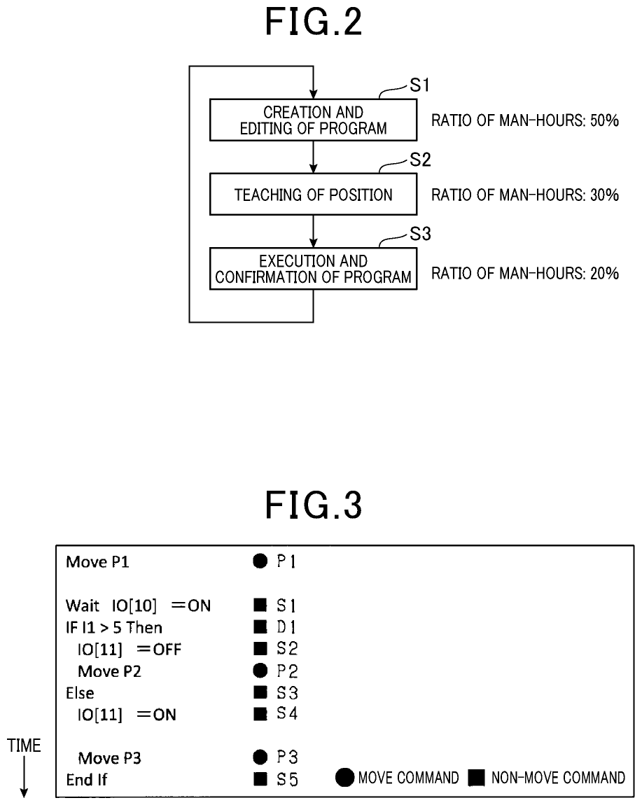

FIG. 2 is a flowchart showing the steps until program completion. A series of these steps are performed under the instruction of the operator by using the teaching pendant 30.

First, as shown in the figure, creation and editing of a program are performed (step S1). The program according to this example includes move commands for moving the robot 10 and non-move commands, which are commands other than the move commands. The operator creates programs by sequentially describing these commands. Further, the operator edits the program based on the execution result of the created program. The ratio of man-hours in this step accounts for, for example, approximately 50% of the total man-hours until program completion.

Subsequently, teaching of each target position in an operation space of the robot 10 is performed based on the work to be performed by the robot 10 (step S2). The operator teaches each target position by directly describing each target position of each move command in the program, or by instructing each target position in the simulation image of the robot 10. The ratio of man-hours in this step accounts for, for example, approximately 30% of the total man-hours until program completion.

Subsequently, execution and confirmation of the program are performed (step S3). The operator executes and confirms the program by executing the program to actually move the robot 10, or by confirming the movement of the robot 10 in the simulation image. The ratio of man-hours in this step accounts for, for example, approximately 20% of the total man-hours until program completion.

The programming support device of the present embodiment supports all the above steps. That is, the teaching pendant 30 supports not only recognition of the movement (e.g., target position and motion trajectory) of the robot 10, but also creation and editing of the program, and teaching of the target position. FIG. 3 is a schematic diagram showing part of the program, which is executed by each command (line or step) in sequence from the top. It should be noted that the actual program for operating the robot 10 may be described by thousands of lines of commands (instructions).

The instructions in the example shown in FIG. 3 will now be described. “Move P1” is a move command for moving a control point (distal end of the sixth arm) of the robot 10 to a target position P1. “Wait IO[10]=ON” is a standby command (non-move command) for causing the robot 10 to wait until an IO port [10] is turned ON. “IF I1>5 Then” is a determination command (IF statement: non-move command) for determining whether or not a variable I1 is larger than 5. “IO[11]=OFF” is an output command (non-move command, non-determination command) for outputting OFF to an IO port [11]. “Move P2” is a move command for moving the control point of the robot 10 to a target position P2. “Else” is an instruction command (ELSE statement: non-move command, non-determination command) for instructing a process when the IF condition is not satisfied. “Move P3” is a move command for moving the control point of the robot 10 to a target position P3. “End if” is an instruction command (non-move command, non-determination command) for indicating the end of the IF condition.

As described above, the program of the robot 10 includes a larger number of non-move commands than the move commands. It has been known that a target position of the move command is displayed on the simulation image which simulates the movement of the robot 10. However, it has been difficult to recognize at which position and timing the non-move commands are executed. In this regard, according to the present embodiment, the non-move commands as well as the target positions of the move commands are displayed.

FIG. 4 is an image (that is, a simulation image) which schematically illustrates the robot 10, the motion trajectories, and the command symbols. The image shown in FIG. 4 is displayed on the display 31 (see FIG. 5) of the teaching pendant 30 during creation and editing of the program shown in FIG. 3. Further, in the display image of the display 31 shown in FIG. 5, a fence WL surrounding the robot 10 is also synthesized and displayed.

The teaching pendant 30 displays the motion trajectories L1 to L3 of the robot 10 as well as an image 10A of the robot 10 on the display 31. The operator can specify the range of the motion trajectories to be displayed. For example, a circle mark PO represents a movement start position of the robot 10. Circle marks P1 to P3 represent the respective target positions of the move commands (Move) of the robot 10. That is, the teaching pendant 30 (which serves as the first processing unit) displays the target positions P1 to P3 based on the respective move commands, superimposed on the motion trajectories L1 to L3. Each of the target positions P1 to P3 are displayed at positions corresponding thereto as a circle mark (first symbol).

Square marks S1 to S5 represent the respective non-move commands. The square mark S1 represents the position (timing) at which the standby command (Wait) is executed. The square mark S1 is displayed at a position corresponding to the timing when the standby command is executed between the target position P1 and the target positions P2 and P3 (a position of the target position P1 or a position adjacent to the target position P1). The square mark S2 represents the position (timing) at which the output command (IO[11]=OFF) is executed. The square mark S2 is displayed at a position corresponding to the timing when the output command is executed between the target position P1 and the target position P2 (a position adjacent to the execution position of the immediately preceding command).

Further, the square mark S3 represents the position (timing) at which the instruction command (Else) is executed. The square mark S3 is displayed at a position corresponding to the timing when the instruction command is executed between the target position P1 and the target position P3. The square mark S4 represents the position (timing) at which the output command (IO[11]=ON) is executed. The square mark S4 is displayed at a position corresponding to the timing when the output command is executed between the target position P1 and the target position P3 (a position adjacent to the execution position of the immediately preceding command). The square mark S5 represents the position (timing) at which the instruction command (End if) is executed. The square mark S5 is displayed at a position corresponding to the timing when the instruction command is executed on the further side of the target position P2 or P3 (a position of the target position P2 or P3, or a position adjacent to the target position P2 or P3).

That is, the teaching pendant 30 (which serves as the second processing unit) displays each of the non-move commands executed between the move commands, that is, “Move P1” (first move command) and “Move P2” or “Move P3” (second move command) by using the square mark (second symbol), which is different from the circle mark, superimposed on the motion trajectories L1 to L3 between the target position P1 of the first move command and the target position P2 or P3 of the second move command.

The rhombic mark D1 represents the position (timing) at which the determination command (IF I1>5 Then) is executed. The rhombic mark D1 represents the position (timing) at which the determination command (IF I1>5 Then) is executed. The rhombic mark D1 is displayed at a position corresponding to the timing when the determination command is executed between the target position P1 and the target positions P2 and P3 (a position adjacent to the execution position of the immediately preceding command). That is, the teaching pendant 30 (second processing unit) displays each of the non-move commands executed between the move commands, that is, “Move P1” (first move command) and “Move P2” or “Move P3” (second move command) by using the rhombic mark (second symbol), which is different from the circle mark, superimposed on the motion trajectories L1 to L3 between the target position P1 of the first move command and the target position P2 or P3 of the second move command.

The teaching pendant 30 (which also serves as the third processing unit) is capable of selecting the circle marks P0 to P3, the square marks S1 to S5, and the rhombic mark D1, and editing the command corresponding to the selected symbol in the program. The details will be described below in connection with FIG. 5.

FIG. 5 is a view illustrating an exemplary display on the display 31 of the teaching pendant 30.

The teaching pendant 30, that is, the microcomputer 30A determines a set of commands corresponding to the selected symbol in the program (S11), and displays it on the display 31 in the editable state (S12). For example, when any of the circle marks P1 to P3, the square marks S1 to S5, and the rhombic mark D1 is selected, the selected set of commands is displayed as shown in the left split screen in the image shown in FIG. 5.

Further, the teaching pendant 30 may also display a set of commands, in the program, including the commands executed on the motion trajectories L1 to L3, which are specified and displayed by the operator, on the display 31 in the editable state. Further, the teaching pendant 30 may also display a set of commands, in the program, including the commands located between the move commands for move to the target positions P1 to P3 included in the motion trajectories L1 to L3 on the display 31 in the editable state.

The teaching pendant 30 enables the displayed program to be edited by the operator when operating the various key switches 30B.

The teaching pendant 30 displays next part of the program when the operator presses a button B1 (provided on a touch panel). The teaching pendant 30 displays previous part of the program when the operator presses a button B2 (provided on the touch panel). That is, the teaching pendant 30 is capable of selecting a part of the program and displaying the selected part of the program on the display 31.

The teaching pendant 30 may also display the motion trajectory of the robot 10 and the respective commands defined by the displayed part of the program on the display 31. That is, the teaching pendant 30 may also display, among the motion trajectory of the robot 10 and the symbols representing the respective commands of the program, a portion corresponding to a part of the selected command in the program on the display 31.

The operator can rewrite the program not only by directly editing the displayed program, but also by changing the position of the symbol on the displayed image. That is, the teaching pendant 30 is capable of changing the position of the displayed circle mark, and, as the position of the circle mark is changed, the teaching pendant 30 can also rewrite the target position of the move command in the program, which corresponds to the circle mark that has been changed, into a position corresponding to the changed position.

The aforementioned present embodiment has advantageous effects as described below.
The teaching pendant 30 displays the respective target positions P1 to P3 of the move commands (Move) by using the circle marks P1 to P3 superimposed on the motion trajectories L1 to L3 of the robot 10 at positions corresponding to the respective target positions P1 to P3. Accordingly, the operator can easily recognize the respective target positions P1 to P3 of the move commands on the motion trajectories L1 to L3 of the robot 10 on the basis of the circle marks P1 to P3. Accordingly, the operator can easily recognize the respective target positions P1 to P3 of the move commands on the motion trajectories L1 to L3 of the robot 10 on the basis of the circle marks P1 to P3. The teaching pendant 30 displays each of the non-move commands executed between the move commands, that is, the first move command and the second move command, by using the square mark and the rhombic mark, which are different from the circle mark, superimposed on the motion trajectories L1 to L3 between the target position P1 of the first move command and the target position P2 or P3 of the second move command. Accordingly, the operator can intuitively recognize not only the respective target positions P1 to P3 of the move commands, but also the position and timing at which the respective non-move commands are executed on the basis of the square mark and the rhombic mark.
The teaching pendant 30 is capable of selecting the circle mark, the square mark, and the rhombic mark, and editing the command corresponding to the selected symbol. Accordingly, the operator can intuitively select the move commands and the non-move commands to edit, and smoothly shift to editing of the commands. Therefore, the teaching pendant 30 improves usability in programming for the robot 10.
The teaching pendant 30 displays a portion of the program which includes the commands corresponding to the selected symbols on the display 31 in the editable state. Accordingly, the operator can easily find the command corresponding to the selected symbol, that is, the command to edit in the program, and edit the command.
The teaching pendant 30 is capable of selecting a part of the program and displaying the selected part of the program on the display 31, and displays, among the motion trajectories L1 to L3, the circle mark, the square mark, and the rhombic mark, a portion corresponding to the selected part of the program on the display 31. Accordingly, the operator can easily recognize the motion trajectories L1 to L3, the circle mark, the square mark, and the rhombic mark corresponding to the selected part of the program.
The teaching pendant 30 is capable of changing the position of the displayed circle mark. Accordingly, when desiring to change the target position of the move command, the operator can change the position of the displayed circle mark. As the position of the circle mark is changed, the teaching pendant 30 rewrites the target position of the move command in the program corresponding to the circle mark that has been changed into a position corresponding to the changed position. Accordingly, the operator can easily rewrite the target position of the move command in the program corresponding to the circle mark by changing the position of the displayed circle mark.
The teaching pendant 30 displays each of the non-move commands executed between the first move command and the second move command, by using the square mark or the rhombic mark, at a position corresponding to the timing when the non-move command is executed. Accordingly, the operator can recognize the timing at which each of the non-move commands are executed on the basis of the position of the square mark or the rhombic mark.
The teaching pendant 30 displays the determination command and the non-determination command among the non-move command by using the rhombic mark and the square mark, respectively. Accordingly, the operator can independently recognize the determination command and the non-determination command among the non-move commands.

The above embodiment can be implemented with the following modification. The same components as those of the above embodiment are denoted by the same reference signs, and the description thereof will be omitted.
The determination command and the non-determination command may also be displayed by using individual symbols (second symbol) different from the rhombic mark and the square mark. The move command may also be displayed by using a symbol (first symbol) different from the circle mark. However, the first symbol and the second symbol should be different from each other.
In the above embodiment, the programming support device is implemented as the teaching pendant 30. Alternatively, the programming support device can also be implemented by a personal computer and a monitor (display unit) connected to the controller 20.
In a glasses-type display device for displaying a virtual image superimposed on the real scene, it is also possible to display the motion trajectories L1 to L3 of the robot 10, the target positions P1 to P3, and the first symbol and the second symbol representing the respective commands at a position corresponding to the robot 10. Specifically, the programming support device obtains a viewpoint position of the operator via the glasses-type display device, obtains an installation position and a posture of the robot 10 from the controller 20, the teaching pendant 30, or a pre-set data, and displays a virtual image superimposed on the operator's field of view on be basis of the viewpoint position of the operator, and the installation position and the posture of the robot 10.
The robot 10 is not limited to the vertical articulated robot, and may also be a horizontal or other types of articulated robot.

### <Modifications>

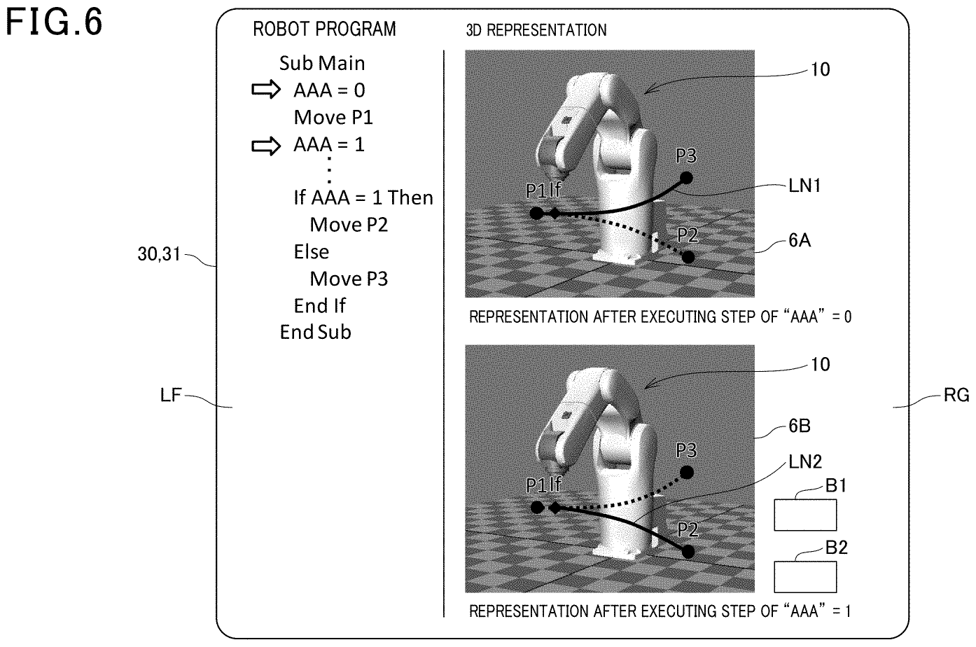

With reference to FIGS. 6 to 9, modifications of the programming support device functionally implemented by the teaching pendant 30 according to the aforementioned embodiment will be described. In the modifications, the same or similar components as those of the above embodiment are denoted by the same reference signs, and the description thereof will be omitted or simplified.

### First Modification

Referring to FIG. 6, a first modification will now be described. FIG. 6 illustrates an example of a 3D image displayed on the display 31 of the teaching pendant 30. This image illustrates part of the programming (robot programming) process for driving the robot 10 by using the microcomputer 30A, which is performed in interactive cooperation with the operator.

According to this image, a left split screen LF displays a part of the robot program under the process of creation or editing or execution or confirmation, which is executed as part of the simulation, in real time as it is created, whereas a right split screen RG displays dynamic changes of the motion trajectory of the robot (the trajectory of the distal end of the robot arm) according to an example of the robot programming process.

In the robot program, a command (line of step) for setting a variable AAA=0 or AAA=1, which is one of the non-move commands, is described. Although not shown, between the variable AAA=1 and the IF statement, there are instructions related to the event for setting the variable AAA=0.

Accordingly, when a starting point of the motion trajectory is set to the variable AAA=0 as the initial value by the microcomputer 30A, a position P1 (• mark) is displayed as shown in an upper image 6A in the right split screen RG of the display 30. Then, after the variable AAA=1 which is set after a predetermined time, one or more other instructions are executed, and then the IF statement is executed. Accordingly, a ♦ mark is superimposed on the motion trajectory of the distal end of the robot.

In the course of execution of instructions, when the variable AAA=0 is set due to a change in the event at the timing other than when the variable AAA=0 is set as the initial value, the motion trajectory is displayed as a solid line LN 1 as shown in the upper image 6A of the right split screen RG of the display 30. Then, at the timing when the variable AAA=1 is set, the motion trajectory of the distal end of the robot arm is dynamically changed from the previous solid line LN1 shown in the previous image (upper image 6A) to another solid line LN 2 shown in a lower image 6B. The points P1, P2, and P3 represent positions in the operation space of the robot 10. Further, when the variable AAA=1, which is the non-move command, is updated to the variable AAA=0, the 3D image of the robot is dynamically updated from the lower image 6B to the upper image 6A.

Accordingly, the operator can visually recognize that the determination result of the IF statement, which is the determination command, has been changed in the simulation.

### Second Modification

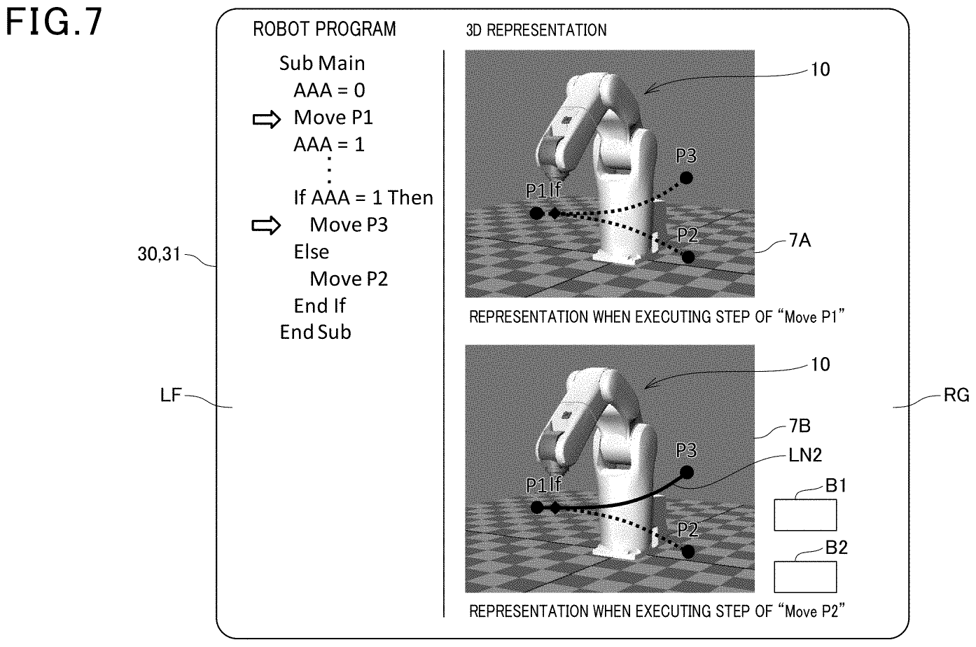

Referring to FIG. 7, a second modification will now be described. FIG. 7 illustrates an example of the 3D image displayed on the display 31 of the teaching pendant 30. This image also illustrates part of the programming (robot programming) process for driving the robot 10 by using the microcomputer 30A, as with the first modification.

As shown in FIG. 7, the robot program shown in the left split screen LF of the display 30 is the same as that of the first modification. In the second modification, the microcomputer 30A is configured to dynamically change the 3D display of the robot when the move commands “Move P1” and “Move P3” are executed in the simulation (see an upper image 7A and a lower image 7B in the right split screen RG).

That is, when the move command “Move P1” is executed by the microcomputer 30A in a state in which the variable AAA=0 is set, the 3D display of the robot is performed as shown in the upper image 7A. Subsequently, after the variable AAA=1 is set, other instructions are executed to reach the IF statement. Then, “Move P2” is executed. Accordingly, the 3D display of the robot is dynamically changed as indicated by the solid line LN2 in the lower image 7B. Similarly, when the variable AAA=0 is set at the timing other than when the variable AAA=0 is set as the initial value, the image is dynamically changed to the image showing the position P2.

Accordingly, the operator can visually recognize that a different move command has been executed in the simulation.

It should be noted that the dotted line shown in FIGS. 6 and 7 indicate virtual lines, and are not necessarily displayed in the simulation image. However, when the past trajectory that has been already simulated is displayed, a dotted line, virtual line, or a line of a different color may be displayed in a superimposed manner. The desired points P1, P2, and P3 in the operation space may also be displayed in the simulation image in a superimposed manner at the timing when the move commands that specify these points are written or executed.

### Third Modification

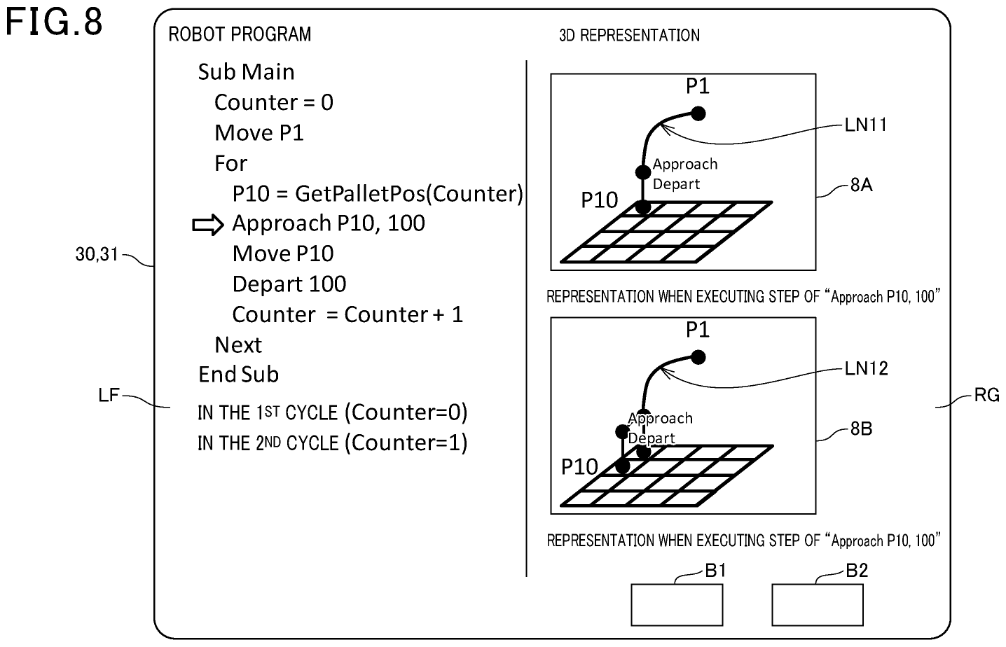

Referring to FIG. 8, a third modification will now be described. FIG. 8 illustrates an example of the 3D image displayed on the display 31 of the teaching pendant 30. This image also illustrates part of the programming (robot programming) process for driving the robot 10 by using the microcomputer 30A, as with the above modifications.

In this robot program, a counter “Counter” is used as a simulation by the microcomputer 30A (see the left split screen LF). When the robot program is executed, the initial value is set to the operation instruction: Counter=0. Subsequently, the move command “Move P1” is executed, and an operation instruction: target position P10 is set (P10=GetPalletPos(Counter)) determined by a desired function GetPalletPos(Counter) by using the counter as a variable.

The distal end of the robot arm is instructed to approach the position P10 determined by this function with a desired physical quantity 100 (move command: Approach P10, 100). When it is moved to the position (move command: Approach P10), the physical quantity 100 is released at the position P10 (move command: Depart 100). Accordingly, for example, an operation is performed to carry an object to an initial position of a grid-shaped pallet and place the object at the position. This operation is repeated by incrementing the Counter (non-move command: Counter=Counter+1).

In this repetition, each time the operation instruction P10=GetPalletPos(Counter) is executed, the 3D display is dynamically changed by the microcomputer 30A as shown in an upper image 8A and a lower image 8B in the right split screen RG. That is, each time the counter is incremented to issue the operation instruction, the display is updated at the timing of operation.

Accordingly, the operator can visually recognize the motion trajectory of the distal end of the robot arm each time a value of the counter, which is a different move command, is changed in the simulation.

### Fourth Modification

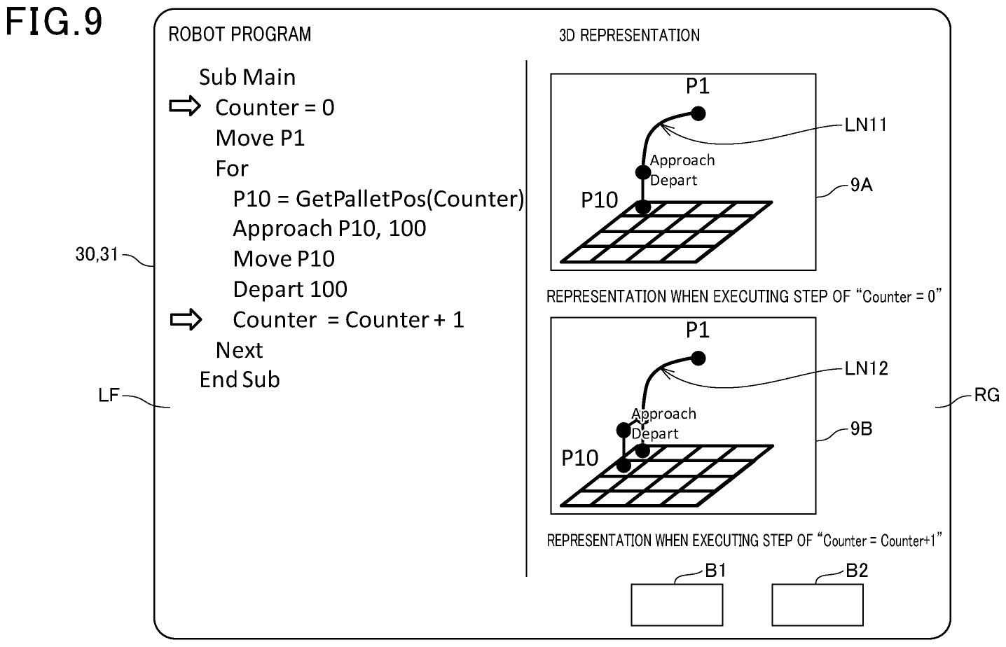

Referring to FIG. 9, a fourth modification will now be described. FIG. 9 illustrates an example of the 3D image displayed on the display 31 of the teaching pendant 30. This image also illustrates part of the programming (robot programming) process for driving the robot 10 by using the microcomputer 30A, as with the third modification.

This robot program is executed by the microcomputer 30A as part of a simulation. The content of the program is the same as that of the program shown in FIG. 8 except that, each time the counter is incremented, the schematic 3D display is dynamically changed by the microcomputer 30A as shown in an upper image 9A and a lower image 9B in the right split screen RG. Although FIG. 9 shows only two counters, i.e., Counter=0 and 1, the display is dynamically updated each time the counter is changed by Counter=0, 1, 2 . . . N (a predetermined maximum value).

Accordingly, the operator can visually recognize the motion trajectory of the distal end of the robot arm each time a value of the counter is changed in the simulation.

Although the 3D display results of the motion trajectories of FIGS. 8 and 9 are the same, the display timings thereof are different.

As described above, according to the first to fourth modifications as well, the degree of freedom in selection of superimposed display of the motion trajectory of the distal end of the robot arm and the command can be increased during programming for industrial robots. Therefore, these modifications can also improve usability in programming for industrial robots.

1. A device which supports programming for robots, and includes a display unit that displays a motion trajectory of a robot at a position corresponding to the robot and supports programming in which move commands for moving the robot and non-move commands, which are commands other than the move commands, are included, by using the display unit, the device comprising:
a first processing unit that displays, on the display unit, each target position of each of the move commands by using a first symbol superimposed on the motion trajectory at a position corresponding to the target position;
a second processing unit that displays, on the display unit, each of the non-move commands executed between the move commands, that is, a first move command and a second move command, by using a second symbol, which is different from the first symbol, superimposed on the motion trajectory between the target position of the first move command and the target position of the second move command; and
a third processing unit capable of selecting the first symbol and the second symbol, and editing the command corresponding to the selected symbol.

2. The device which supports programming for robots according to claim 1, wherein the third processing unit displays a portion of the program which includes the command corresponding to the selected symbol on the display unit in an editable state.

3. The device which supports programming for robots according to claim 2, wherein the third processing unit is capable of selecting a part of the program and displaying the selected part of the program on the display unit, and displays, among the motion trajectory, the first symbol, and the second symbol, a portion corresponding to the selected part of the program on the display unit.

4. The device which supports programming for robots according to claim 3, wherein the third processing unit is capable of changing a position of the displayed first symbol, and, as the position of the first symbol is changed, the third processing unit rewrites the target position of the move command in the program corresponding to the first symbol that has been changed into a position corresponding to the changed position.

5. The device which supports programming for robots according to claim 4, wherein the second processing unit displays each of the non-move commands executed between the first move command and the second move command, by using the second symbol, superimposed on the motion trajectory at a position corresponding to the timing when the non-move command is executed between the target position of the first move command and the target position of the second move command.

6. The device which supports programming for robots according to claim 5, wherein the second processing unit displays a determination command and a non-determination command among the non-move commands by using different second symbols.

7. The device which supports programming for robots according to claim 1, wherein the third processing unit is capable of selecting a part of the program and displaying the selected part of the program on the display unit, and displays, among the motion trajectory, the first symbol, and the second symbol, a portion corresponding to the selected part of the program on the display unit.

8. The device which supports programming for robots according to claim 7, wherein the third processing unit is capable of changing a position of the displayed first symbol, and, as the position of the first symbol is changed, the third processing unit rewrites the target position of the move command in the program corresponding to the first symbol that has been changed into a position corresponding to the changed position.

9. The device which supports programming for robots according to claim 8, wherein the second processing unit displays each of the non-move commands executed between the first move command and the second move command, by using the second symbol, superimposed on the motion trajectory at a position corresponding to the timing when the non-move command is executed between the target position of the first move command and the target position of the second move command.

10. The device which supports programming for robots according to claim 9, wherein the second processing unit displays a determination command and a non-determination command among the non-move commands by using different second symbols.

11. The device which supports programming for robots according to claim 1, wherein the third processing unit is capable of changing a position of the displayed first symbol, and, as the position of the first symbol is changed, the third processing unit rewrites the target position of the move command in the program corresponding to the first symbol that has been changed into a position corresponding to the changed position.

12. The device which supports programming for robots according to claim 11, wherein the second processing unit displays each of the non-move commands executed between the first move command and the second move command, by using the second symbol, superimposed on the motion trajectory at a position corresponding to the timing when the non-move command is executed between the target position of the first move command and the target position of the second move command.

13. The device which supports programming for robots according to claim 12, wherein the second processing unit displays a determination command and a non-determination command among the non-move commands by using different second symbols.

14. The device which supports programming for robots according to claim 1, wherein the second processing unit displays each of the non-move commands executed between the first move command and the second move command, by using the second symbol, superimposed on the motion trajectory at a position corresponding to the timing when the non-move command is executed between the target position of the first move command and the target position of the second move command.

15. The device which supports programming for robots according to claim 14, wherein the second processing unit displays a determination command and a non-determination command among the non-move commands by using different second symbols.

16. The device which supports programming for robots according to claim 1, wherein the second processing unit displays a determination command and a non-determination command among the non-move commands by using different second symbols.
